(19) United States
(12) Patent Application Publication
(10) Pub. No.: US 2024/0368771 A1
(43) Pub. Date: Nov. 7, 2024

(54) CUSHION TANK DEVICE

(71) Applicant: JFE Steel Corporation, Tokyo (JP)

(72) Inventors: Kazuhiro Morimoto, Chiyoda-ku, Tokyo (JP); Ryosuke Ikeda, Chiyoda-ku, Tokyo (JP)

(73) Assignee: JFE Steel Corporation, Tokyo (JP)

(21) Appl. No.: 18/684,983

(22) PCT Filed: Aug. 1, 2022
(86) PCT No.: PCT/JP2022/029523

§ 371 Date: Feb. 20, 2024

(30) Foreign Application Priority Data
Oct. 20, 2021 (JP) 2021-171334

(51) Int. Cl. C23G 3/02; B08B 9/093

(52) U.S. Cl. CPC C23G 3/021; B08B 9/0933; B08B 2209/08

(57) ABSTRACT

A cushion tank device includes: a cushion tank configured to store pickling solution and sludge discharged from a pickling tank; a discharge pipe provided on a bottom of the cushion tank and configured to discharge the sludge to an outside of the cushion tank; and an opening/closing member configured to open and close the discharge pipe. The cushion tank device configure to guide the sludge to the discharge pipe, the inclined surface including an inclined surface part on a lower part of the cushion tank that is inclined to horizon at an angle greater than an angle of repose of the sludge with respect to an inner wall surface of the cushion tank.

### CROSS REFERENCE TO RELATED APPLICATIONS

This is the U.S. National Phase application of PCT/JP2022/029523, filed Aug. 1, 2022, which claims priority to Japanese Patent Application No. 2021-171334, filed Oct. 20, 2021, the disclosures of these applications being incorporated herein by reference in their entireties for all purposes.

### FIELD OF THE INVENTION

The present invention relates to a cushion tank device that can store pickling solution and sludge from a pickling tank for pickling a steel strip.

### BACKGROUND OF THE INVENTION

Conventionally, pickling is performed on a hot rolled steel strip to remove scales adhering to the surface of the steel strip and the like, before cold rolling is performed. Specifically, a plurality of pickling tanks containing pickling solution are disposed in a conveyance direction of a steel strip, and pickling is performed by immersing the steel strip in the pickling solution while the steel strip is continuously passed through the pickling tanks. As a pickling method, there are BOX-type, Shallow-type, jet-type, and Deep-type pickling tanks, or the like. A weir is installed in the BOX-type and Shallow-type pickling tanks, and a jet nozzle is installed in the jet-type pickling tank. The BOX-type, Shallow-type, and jet-type have a higher pickling efficiency than that of the Deep-type, and are widely used.

When the pickling line is stopped, to prevent the steel strip remained in the pickling tank from being over-pickled, the steel strip and the pickling solution need to be separated from each other. In the Shallow-type and Deep-type pickling tanks, when the line is stopped, the steel strip is lifted by a strip lifter or the like to separate the steel strip from the pickling solution. In contrast, because the BOX-type and jet-type pickling tanks have a conveyance roller and a nozzle above the steel strip in the pickling tank, it is difficult to take measures to lift the steel trip to prevent the steel strip from being over-pickled. In general, a cushion tank is also installed in the BOX-type and jet-type pickling tanks. When the line is stopped, the steel strip is prevented from being over-pickled, by temporary sending the pickling solution in the pickling tank to the cushion tank to be stored, and lowering the liquid surface height in the pickling tank to the level where the steel strip does not immerse in the pickling solution.

When a hot-rolled steel strip is pickled, scales on the surface of the steel strip and chemical compounds containing metal and pickling solution are deposited in the pickling tank, the cushion tank, and in the pipes attached to the pickling tank and the cushion tank, in a form of sludge. As the deposition progresses, problems occur such as floating sludge adhering to the steel strip causes abnormality in quality, and the deposited sludge is fixed to prevent the pickling solution from being fed. Therefore, the sludge in the pickling tank, the cushion tank, and the pipes needs to be removed, before the deposition amount of the sludge reaches a specific value. This sludge removal work is performed after the pickling solution is discharged, by sucking the sludge from outside or manually scooping the sludge. Because this work requires to remove sludge in a wide range, there are problems such as the production needs to be stopped for a long period of time, and the labor cost required for cleaning is high.

As methods for preventing sludge from depositing in the pickling tank and for efficiently collecting sludge, a method of installing a jet nozzle in the pickling tank and preventing the sludge from depositing on the bottom of the pickling tank (Patent Literature 1), a method of removing the sludge by adhesion using the magnetic force (Patent Literature 2), a method of discharging sludge by providing an inclined plate and a hopper on the bottom of the pickling tank (Patent Literature 3), a method of installing a sludge discharge device including a movable scraper in the acid system (Patent Literature 4), and the like have been developed.

### PATENT LITERATURE

Patent Literature 1: Japanese Patent Application Laid-open No. 2021-14601

Patent Literature 2: Japanese Patent Application Laid-open No. 2000-189834

Patent Literature 3: Japanese Unexamined Utility Model Registration Application Publication No S62-122864

Patent Literature 4: Japanese Patent Application Laid-open No. S62-27581

### SUMMARY OF THE INVENTION

However, with the method of installing a jet nozzle in the pickling tank disclosed in Patent Literature 1, there is a problem in that the method cannot be applied to a pickling tank where many weirs are disposed as in the BOX-type, because there is no space for installing a jet nozzle. Moreover, although the jet nozzle prevents the sludge from depositing on the bottom of the pickling tank, the sludge still needs to be collected from the attached tanks and pipes in a conventional manner.

In the method of removing the sludge by adhesion using the magnetic force disclosed in Patent Literature 2, the collectable sludge is limited to sludge in which the main component has magnetic properties such as Fe. Therefore, there is a problem in that the sludge in which the main component is Si generated during the pickling of high-tensile steel and electromagnetic materials cannot be collected. Moreover, because the method removes the sludge by adhesion, there is a problem in that the sludge having entered the inside of the device needs to be cleaned.

In the structure where an inclined plate and a hopper are provided on the bottom of the pickling tank disclosed in Patent Literature 3, an extra space is required in the pickling tank. Hence, there is a problem in that the structure cannot be applied to the BOX-type and jet-type pickling tanks. Moreover, due to the space restriction in the pickling tank, the angle of the inclined plate cannot be set large. Hence, there is a problem in that the sludge deposited on the inclined plate does not flow to the hopper and is piled up thereon. In addition, the aperture of the lower part of the hopper is small compared to the capacity of the pickling tank. Hence, there is a problem in that the sludge is fixed to the lower part of the hopper and is prevented from being discharged. Furthermore, to install the facility with such a structure, the pickling tank main body needs to be updated or remodeled. Hence, there are problems such as the installation cost and the construction period will be increased.

In the method of installing a sludge removal device including a movable scraper in the acid system disclosed in Patent Literature 4, the scraper is easily broken by the fixed sludge, and the scraper needs to be changed frequently due to abrasion caused by the contact with the sludge. Moreover, because the pickling sludge is extremely light in weight, it takes a relatively long time to settle. Hence, there is a problem in that the sludge floated in the sludge removal device flows out from an overflow pipe, and is returned to the pickling tank. Furthermore, when the lower valve of the sludge removal device is opened, a large amount of pickling solution is discarded with the sludge. Hence, there is a problem in that the consumption rate will be worsened. Still furthermore, a large-scale sludge removal device needs to be installed anew in the acid system, and in many cases, the existing facility needs to be remodeled. Hence, there are problems in installation cost and construction period.

Aspects of the present invention have been made in view of the above problems, and an object of the present invention is to provide a cushion tank device that can efficiently discharge sludge with a simple structure.

To solve the above-described problem and achieve the object, a cushion tank device according to aspects of the present invention includes: a cushion tank configured to store pickling solution and sludge discharged from a pickling tank; a discharge pipe provided on a bottom of the cushion tank and configured to discharge the sludge to an outside of the cushion tank; and an opening/closing member configured to open and close the discharge pipe, wherein the cushion tank device configure to guide the sludge to the discharge pipe, the inclined surface including an inclined surface part on a lower part of the cushion tank that is inclined to horizon at an angle greater than an angle of repose of the sludge with respect to an inner wall surface of the cushion tank.

Moreover, in the above-described cushion tank device according to aspects of the present invention, an angle of the inclined surface part is 45 degrees to 80 degrees with respect to the horizon.

Moreover, the above-described cushion tank device according to aspects of the present invention further includes a plurality of liquid feeding pipes disposed on the lower part of the cushion tank at different positions in a height direction of the cushion tank and configured to feed the pickling solution from the cushion tank to the pickling tank.

Moreover, the above-described cushion tank device according to aspects of the present invention further includes a cleaning pipe configured to deliver cleaning solution along an inner wall surface of the cushion tank device.

Moreover, in the above-described cushion tank device according to aspects of the present invention, the cleaning pipe is disposed such that the cleaning solution is capable of being delivered in a tangential direction at any position on the inner wall surface of the cushion tank.

Moreover, in the above-described cushion tank device according to aspects of the present invention, the cleaning pipe is disposed such that an angle between a normal line at any position on the inner wall surface of the cushion tank and the cleaning pipe is 45 degrees to 135 degrees.

The cushion tank device according to aspects of the present invention can efficiently discharge sludge with a simple structure.

### BRIEF DESCRIPTION OF THE DRAWINGS

FIG. 1 is a diagram illustrating a schematic configuration of a pickling facility including a cushion tank device according to an embodiment.

FIG. 2 is a front view illustrating a schematic configuration of the cushion tank device according to the embodiment.

FIG. 3 is a plan view illustrating a schematic configuration of the cushion tank device according to the embodiment.

### DETAILED DESCRIPTION OF EMBODIMENTS OF THE INVENTION

Hereinafter, an embodiment of a cushion tank device according to aspects of the present invention will be described. However, the present invention is not limited to the present embodiment.

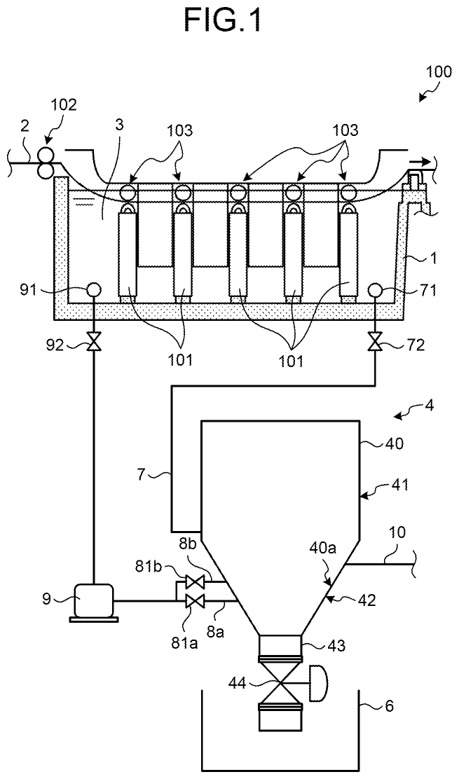

FIG. 1 is a diagram illustrating a schematic configuration of a pickling facility 100 including a cushion tank device 4 according to the embodiment.

As illustrated in FIG. 1, the pickling facility 100 according to the embodiment includes a pickling tank 1, a cushion tank device 4, a sludge collection tank 6, a liquid feeding pipe 7, and a liquid feeding pump 9. Moreover, the cushion tank device 4 according to the embodiment includes a cushion tank 40, a discharge pipe 43, a discharge valve 44, liquid feeding pipes 8a and 8b, a cleaning pipe 10, and the like.

In the pickling facility 100 according to the embodiment, the pickling tank 1 containing a pickling solution 3 is divided by a plurality of weirs 101 along a conveyance direction of a steel strip 2. The steel strip 2 is conveyed while being continuously immersed in the pickling solution 3 in the pickling tank 1, by a pair of conveyance rollers 102 provided on the entrance of the pickling tank 1, a plurality of pairs of conveyance rollers 103 provided on the upper part of each of the weirs 101, and the like. By being continuously immersed in the pickling solution 3 in the pickling tank 1, scales adhering to the front surface and the rear surface of the steel strip 2 or the like are cleaned. Moreover, by cleaning the steel strip 2 in this way, sludge produced as a by-product by the reaction between the steel strip 2 and the pickling solution 3 is deposited on the bottom of the pickling tank 1.

During a periodical maintenance and the like, by opening an opening/closing valve 72, the sludge deposited on the bottom of the pickling tank 1 flows out from an outlet port 71 provided on the lower part of the pickling tank 1 on the downstream side in the conveyance direction of the steel strip 2, with the pickling solution 3. The outflow pickling solution 3 and sludge are discharged into the cushion tank 40 in the cushion tank device 4 provided under the pickling tank 1, through the liquid feeding pipe 7.

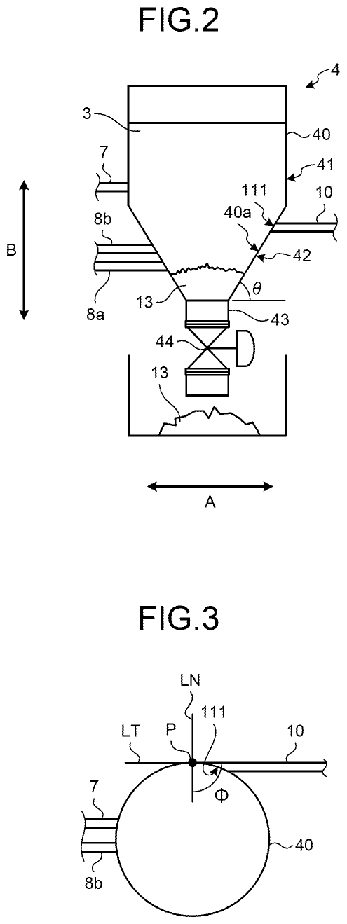

FIG. 2 is a front view illustrating a schematic configuration of the cushion tank device 4 according to the embodiment. In FIG. 2, an arrow A indicates the horizontal direction, and an arrow B indicates the height direction (vertical direction) of the cushion tank 40.

As illustrated in FIG. 2, the cushion tank 40 in the cushion tank device 4 is a storage unit that temporarily stores the pickling solution 3 and the sludge 13 from the pickling tank 1. The cushion tank 40 has a cylindrical part 41 provided on the upper part in the height direction and an inclined surface part 42 provided on the lower part. The liquid feeding pipe 7 for discharging the pickling solution 3 and the sludge 13 from the pickling tank 1 to the cushion tank 40 is connected to the cylindrical part 41 of the cushion tank 40.

The sludge 13 discharged into the cushion tank 40 through the liquid feeding pipe 7 with the pickling solution 3 is allowed to stand and settle in the pickling solution 3, and is deposited on the lower part in the cushion tank 40. Then, after the sludge 13 is completely settled, an opening/closing valve 92 that is provided on a pipe connecting an inlet port 91 provided on the lower part of the pickling tank 1 on the upstream side in the conveyance direction of the steel strip 2, with the liquid feeding pump 9 is opened. At the same time, at least one of an opening/closing valve 81a and an opening/closing valve 81b is opened to activate the liquid feeding pump 9. Consequently, the pickling solution 3 in the cushion tank 40 is fed to the pickling tank 1 by the liquid feeding pump 9 through at least one of the liquid feeding pipe 8a and the liquid feeding pipe 8b.

After the pickling solution 3 is fed from the cushion tank 40 to the pickling tank 1, the discharge valve 44 that is an opening/closing member for opening or closing the discharge pipe 43 provided on the bottom of the cushion tank 40 is opened. Consequently, the sludge 13 in the cushion tank 40 is discharged to the sludge collection tank 6 through the discharge pipe 43.

In this example, the inclined surface part 42 provided on the lower part of the cushion tank 40 according to the embodiment is inclined to the horizon (horizontal direction) at an angle θ, to guide the sludge 13 to the discharge pipe 43. Moreover, the angle θ of the inclined surface part 42 is set larger than the angle of repose of the sludge 13 with respect to an inner wall surface 40a of the inclined surface part 42. The angle of repose in this example refers to the limit angle at which the sludge 13 having been wet by the pickling solution 3 does not slide out from the inner wall surface 40a of the inclined surface part 42. Therefore, in the present embodiment, an angle θ of the inclined surface part 42 can also be referred to as an angle of an inner wall surface 42a of the inclined surface part 42 with respect to the horizon (horizontal direction).

In the cushion tank device 4 according to the embodiment, the inclined surface part 42 is inclined with respect to the horizontal direction at the angle θ greater than the angle of repose described above. Thus, when the sludge 13 is discharged from the discharge pipe 43 to the sludge collection tank 6 by opening the discharge valve 44, the sludge 13 on the inner wall surface 40a flows down toward the discharge pipe 43 along the inclined surface part 42 by the self-weight. In this manner, in the cushion tank device 4 according to the embodiment, the sludge 13 hardly stays in the cushion tank 40 and is discharged to the sludge collection tank 6. Therefore, with the cushion tank device 4 according to the embodiment, it is possible to efficiently discharge the sludge 13 from the cushion tank 40 with a simple structure, and collect the sludge 13 in the sludge collection tank 6.

Because the components, the grain size, the moisture amount, and the like of the sludge differ depending on the materials to be pickled and the conditions, the angle θ may be greater than the angle of repose under the actual conditions. In the cushion tank 40 according to the embodiment, for example, the angle θ of the inclined surface part 42 is preferably 45°≤θ≤80°, and is suitably 60°≤θ≤80°.

If the angle θ of the inclined surface part 42 is 45° or more, the sludge 13 tends to flow down easily from the inclined surface part 42 toward the discharge pipe 43 by the self-weight, and the sludge 13 hardly stays on the inner wall surface 40a of the inclined surface part 42.

Moreover, under the conditions in which the diameters of the cushion tank 40 are the same in the upper end portion of the inclined surface part 42 in the height direction of the cushion tank 40, the diameter of the cushion tank 40 in the lower end portion of the inclined surface part 42 needs to be increased with the increase in the angle θ of the inclined surface part 42. Therefore, with an increase in the angle θ of the inclined surface part 42, the diameter of the discharge pipe 43 connected to the lower end portion of the inclined surface part 42 is increased, and the diameter of the discharge valve 44 connected to the discharge pipe 43 is also increased. If the angle θ of the inclined surface part 42 is 80° or less, there is no need to increase the diameter of the discharge valve 44 more than necessary. Hence, with respect to the effects of making the sludge 13 to flow down toward the discharge pipe 43 from the inclined surface part 42 by the self-weight, it is highly cost effective.

Moreover, in the cushion tank 40 according to the embodiment, the angle θ of the inclined surface part 42 may be stepwisely changed in the height direction of the cushion tank 40. Consequently, it is possible to improve a degree of freedom in designing the shape of the cushion tank 40, installation space, and the like.

Furthermore, in the cushion tank 40 according to the embodiment, it is preferable to dispose the liquid feeding pipes 8a and 8b for feeding the pickling solution 3 from the cushion tank 40 to the pickling tank 1 on different positions in the height direction of the cushion tank 40. In the present embodiment, when the liquid feeding pipe 8a and the liquid feeding pipe 8b are not particularly distinguished from each other, the liquid feeding pipe 8a and the liquid feeding pipe 8b may also be simply referred to as a liquid feeding pipe 8. Moreover, in the cushion tank device 4 illustrated in FIG. 1 and FIG. 2, there are two liquid feeding pipes 8a and 8b. However, the number of the liquid feeding pipe 8 is not limited to two, and may be two or more. Furthermore, it is preferable to dispose the liquid feeding pipes 8 on the inclined surface part 42 of the cushion tank 40.

When multiple liquid feeding pipes 8 are disposed, depending on the deposition amount of the sludge 13 deposited on the lower part of the cushion tank 40, the liquid feeding pipe 8 is selected from the liquid feeding pipes 8a and 8b disposed on different positions in the height direction of the cushion tank 40.

For example, as illustrated in FIG. 2, when the sludge 13 is deposited to the height about the same as that of the liquid feeding pipe 8a on the lower side, the opening/closing valve 81b corresponding to the liquid feeding pipe 8b on the upper side is opened, while the opening/closing valve 81a corresponding to the liquid feeding pipe 8a is closed. Then, the pickling solution 3 is discharged from the cushion tank 40 to the pickling tank 1 using the liquid feeding pipe 8b on the upper side. If the deposition of the sludge 13 is sufficiently lower than the liquid feeding pipe 8a on the lower side, the opening/closing valve 81a corresponding to the liquid feeding pipe 8a is opened, and the pickling solution 3 is discharged from the cushion tank 40 to the pickling tank 1 using at least the liquid feeding pipe 8a on the lower side. In this process, it is also possible to open the opening/closing valve 81b corresponding to the liquid feeding pipe 8b on the upper side, and use the liquid feeding pipe 8b to discharge the pickling solution 3.

Consequently, it is possible to prevent the sludge 13 deposited on the lower part of the cushion tank 40 from returning to the pickling tank 1 with the pickling solution 3. Moreover, it is also possible to reduce the amount of the pickling solution 3 to be discharged to the sludge collection tank 6 through the discharge pipe 43 with the sludge 13.

For example, the following method may be used to determine how high the sludge 13 is deposited on the lower part of the cushion tank 40. If the cushion tank 40 is made of Fiber Reinforced Plastics (FRP), the portion of the sludge 13 will be darker than the surrounding pickling solution 3, when light is emitted from the outside to the inside of the cushion tank 40. This is used to visually determine the height of the deposited sludge 13. Moreover, as another method, the height of the deposited sludge 13 is determined by providing a sludge height detection sensor for detecting the height of the sludge 13 in the cushion tank 40, and on the basis of the detection results of the sludge height detection sensor.

Moreover, in the cushion tank device 4 according to the embodiment, it is preferable to connect the cleaning pipe 10 for delivering cleaning solution from the outside of the cushion tank 40 into the cushion tank 40. Consequently, it is possible to wash away the sludge 13 adhering to the inner wall surface 40a of the cushion tank 40 with cleaning solution. Hence, it is possible to prevent the sludge 13 from remaining on the inner wall surface 40a. Therefore, it is no longer necessary for the workers to enter the cushion tank 40 and collect the sludge 13 adhering to the inner wall surface 40a.

It is preferable to connect the cleaning pipe 10 to the cushion tank 40 such that the cleaning pipe 10 is placed above the maximum deposition height of the sludge 13 in the height direction of the cushion tank 40 that can be obtained from an experiment or operation results in advance. For example, as illustrated in FIG. 2, it is preferable to connect the cleaning pipe 10 to the cushion tank 40 such that a discharge port 111 from which the cleaning solution is discharged is placed on the upper part of the inclined surface part 42 in the height direction of the cushion tank 40.

Moreover, as illustrated in FIG. 3, the cleaning pipe 10 is disposed such that the discharge port 111 can deliver the cleaning solution in the extending direction (tangential direction) of a tangential line LT that passes through a point P that is any position on the inner wall surface 40a of the cushion tank 40. Consequently, it is possible to make the cleaning solution to flow efficiently along the inner wall surface 40a of the cushion tank 40, and efficiently wash away the sludge 13 adhering to the inner wall surface 40a of the cushion tank 40.

However, the cleaning pipe 10 need not be disposed such that the cleaning solution can be delivered in the tangential direction. That is, as illustrated in FIG. 3, it is preferable to dispose the cleaning pipe 10 such that an angle ϕ between a normal line LN that passes through the point P that is any position on the inner wall surface 40a and the cleaning pipe 10 is 45°≤Φ≤135°.

### EXAMPLE

The cleaning frequency of the sludge is compared between the pickling facility (angle θ of the inclined surface part 42 is 60°) in the example of the present invention including the cushion tank device according to aspects of the present invention as illustrated in FIG. 1 and the like, and a conventional pickling facility including a conventional cushion tank device. The cleaning frequency of the sludge in the pickling tank, pipes, and cushion tank is obtained, under an assumption that the pickling facilities were operated for one year and the production rates of steel strips are the same. The results are illustrated in Table 1 below.

TABLE 1

| | Cleaning frequency | | |
|---|---|---|---|
| | Inside pickling | | Inside cushion |
| | tank | Inside pipes | tank |
| Conventional | 12 times per year | 12 times per | 12 times per year |
| example | | year | |
| Example of | Twice per year | Twice per year | Zero per year |
| present invention | | | |

As illustrated in Table 1, with the conventional pickling facility, the inside of the pickling tank, pipes, and cushion tank need to be cleaned 12 times per year. On the other hand, with the pickling facility in the example of the present invention, the cleaning frequency in the pickling tank and pipes was reduced to twice a year, by periodically feeding the pickling solution from the pickling tank to the cushion tank, and settling and collecting the sludge. Moreover, with the pickling facility in the example of the present invention, the cleaning frequency in the cushion tank is reduced to zero per year, and there is no need for workers to clean the cushion tank. Therefore, with the pickling facility in the example of the present invention, it is possible to reduce the line stop time required for cleaning, and reduce the labor cost required for cleaning.

Moreover, with the pickling facility 100 illustrated in FIG. 1, the relation was evaluated between the angle θ (see FIG. 2) of the inclined surface part 42 provided on the lower part of the cushion tank 40 and the remaining of the sludge 13 when the sludge 13 was discharged from the discharge pipe 43 connected to the bottom. The results are illustrated in Table 2 below. In Table 2 below, indicates when the sludge 13 hardly stayed on the inclined surface part 42. “◯” indicates when a small amount of the sludge 13 has stayed on the inclined surface part 42. “x” indicates when a large amount of the sludge 13 has stayed on the inclined surface part 42.

TABLE 2

| Angle θ [°] of inclined | | | | |
|---|---|---|---|---|
| surface part | 0 | 30 | 45 | 60 |
| Evaluation results | X | ◯ | ⊚ | ⊚ |

As apparent from Table 2, when the angle θ of the inclined surface part 42 is 0°, a large amount of the sludge 13 stays on the inclined surface part 42, when the sludge 13 is discharged from the discharge pipe 43 connected to the bottom of the cushion tank 40. Therefore, workers need to enter the cushion tank 40 to remove the sludge. On the other hand, when the angle θ of the inclined surface part 42 is 45° and 60°, the sludge 13 hardly stays on the inclined surface part 42, when the sludge 13 is discharged from the discharge pipe 43 connected to the bottom of the cushion tank 40. Therefore, workers do not need to enter the cushion tank 40 to remove the sludge 13. When the angle θ of the inclined surface part 42 is 30°, a small amount of the sludge 13 has stayed on the inclined surface part 42. However, the sludge 13 can be removed by the cleaning solution.

### INDUSTRIAL APPLICABILITY

According to aspects of the present invention, it is possible to provide a cushion tank device that can efficiently discharge sludge with a simple structure.

### REFERENCE SIGNS LIST

1 pickling tank
2 steel strip
3 pickling solution
4 cushion tank device
6 sludge collection tank
7, 8, 8a, 8b liquid feeding pipe
9 liquid feeding pump
10 cleaning pipe
13 sludge
40 cushion tank
40a inner wall surface
41 cylindrical part
42 inclined surface part
43 discharge pipe
44 discharge valve
71 outlet port
72, 81a, 81b, 92 opening/closing valve
91 inlet port
100 pickling facility
101 weir
102, 103 pair of conveyance rollers
111 discharge port

1. A cushion tank device comprising:
a cushion tank configured to store pickling solution and sludge discharged from a pickling tank;
a discharge pipe provided on a bottom of the cushion tank and configured to discharge the sludge to an outside of the cushion tank; and
an opening/closing member configured to open and close the discharge pipe, wherein
the cushion tank device configure to guide the sludge to the discharge pipe, the inclined surface including an inclined surface part on a lower part of the cushion tank that is inclined to horizon at an angle greater than an angle of repose of the sludge with respect to an inner wall surface of the cushion tank.

2. The cushion tank device according to claim 1, wherein an angle of the inclined surface part is 45 degrees to 80 degrees with respect to the horizon.

3. The cushion tank device according to claim 1, further comprising a plurality of liquid feeding pipes disposed on the lower part of the cushion tank at different positions in a height direction of the cushion tank and configured to feed the pickling solution from the cushion tank to the pickling tank.

4. The cushion tank device according to claim 1, further comprising a cleaning pipe configured to deliver cleaning solution along an inner wall surface of the cushion tank device.

5. The cushion tank device according to claim 4, wherein the cleaning pipe is disposed such that the cleaning solution is capable of being delivered in a tangential direction at any position on the inner wall surface of the cushion tank.

6. The cushion tank device according to claim 4, wherein the cleaning pipe is disposed such that an angle between a normal line at any position on the inner wall surface of the cushion tank and the cleaning pipe is 45 degrees to 135 degrees.

7. The cushion tank device according to claim 2, further comprising a plurality of liquid feeding pipes disposed on the lower part of the cushion tank at different positions in a height direction of the cushion tank and configured to feed the pickling solution from the cushion tank to the pickling tank.

8. The cushion tank device according to claim 2, further comprising a cleaning pipe configured to deliver cleaning solution along an inner wall surface of the cushion tank device.

9. The cushion tank device according to claim 8, wherein the cleaning pipe is disposed such that the cleaning solution is capable of being delivered in a tangential direction at any position on the inner wall surface of the cushion tank.

10. The cushion tank device according to claim 8, wherein the cleaning pipe is disposed such that an angle between a normal line at any position on the inner wall surface of the cushion tank and the cleaning pipe is 45 degrees to 135 degrees.

11. The cushion tank device according to claim 3, further comprising a cleaning pipe configured to deliver cleaning solution along an inner wall surface of the cushion tank device.

12. The cushion tank device according to claim 11, wherein the cleaning pipe is disposed such that the cleaning solution is capable of being delivered in a tangential direction at any position on the inner wall surface of the cushion tank.

13. The cushion tank device according to claim 11, wherein the cleaning pipe is disposed such that an angle between a normal line at any position on the inner wall surface of the cushion tank and the cleaning pipe is 45 degrees to 135 degrees.

14. The cushion tank device according to claim 7, further comprising a cleaning pipe configured to deliver cleaning solution along an inner wall surface of the cushion tank device.

15. The cushion tank device according to claim 14, wherein the cleaning pipe is disposed such that the cleaning solution is capable of being delivered in a tangential direction at any position on the inner wall surface of the cushion tank.

16. The cushion tank device according to claim 14, wherein the cleaning pipe is disposed such that an angle between a normal line at any position on the inner wall surface of the cushion tank and the cleaning pipe is 45 degrees to 135 degrees.
